(19) United States
(12) Patent Application Publication
(10) Pub. No.: US 2026/0155642 A1
(43) Pub. Date: Jun. 4, 2026

(54) CABLE JOINT

(71) Applicant: Hubbell Incorporated, Shelton, CT (US)

(72) Inventor: David Charles Hughes, Aiken, SC (US)

(21) Appl. No.: 19/408,497

(22) Filed: Dec. 4, 2025

Related U.S. Application Data
(60) Provisional application No. 63/727,929, filed on Dec. 4, 2024.

(51) Int. Cl. H02G 15/18; H01R 11/01

(52) U.S. Cl. CPC H02G 15/1806; H01R 11/01

(57) ABSTRACT

A cable joint including an electrode having an end portion and a middle portion. The end portion is thicker than the middle portion.

### RELATED APPLICATIONS

This application claims priority to U.S. Provisional Patent Application No. 63/727,929, filed on Dec. 4, 2024, the entire content of which is hereby incorporated by reference.

### FIELD

The present disclosure relates to cable joints and, more particularly, to thermally optimizing joint electrodes of medium voltage cable joints.

### SUMMARY

Cable joints are used to join or terminate current carrying cables, for example, along a utility line. Two cables are spliced using a connector and the cable joint is provided over the connector to insulate the connector and to provide a strong mechanical connection between the two cables. Cable joints may be heat shrinkable or cold shrinkable. When the heat shrink cable joint is placed over joined cables, heat is applied to the cable joint to compress the cable joint over the connector and to provide a strong mechanical connection between the two cables. When the cold shrink cable joint is placed over joined cables, a support structure that is keeping the cable joint in an expanded state is removed to compress the cable joint over the connector and to provide a strong mechanical connection between the two cables.

In many current medium voltage cable joints, the electrode used to cover the connector is thick and acts as a thermal blanket trapping the heat in the cable joint. Current revision of Institute of Electrical and Electronic Engineers (IEEE) 404 provides the standard for medium voltage cable joints (i.e., cable joints rated for voltage between 2.5 kilovolts (kV) and 500 kV. Testing procedures defined in the IEEE 404 standard do not require the joint connector to run cooler than the control cable in a current cycling test. Testing therefore may not catch these drawbacks during a design phase. As a result, many current medium voltage cable joints experience thermal failures on the field.

One current solution to avoid thermal failure of cable joints is to use an expensive oversized connector with a lot of thermal mass to keep the joint connector running cooler than the control cable. Accordingly, there is a need for an inexpensive cable joint that is thermally optimized for medium voltage applications.

Cable Joints described herein provide a range of technical solutions to these and other technical challenges. For instance, the cable joints described herein allow heat to transfer through faster. This capability offers significant technical benefits, as cable joints may be engineered to keep the connector cooling while not compromising dielectric performance. The cable joints described herein also keep voltage stress low and improve dielectric performance at the edges of the connector and limit a thermal blanket over the connector to transfer heat away from the connector.

According to some examples, a cable joint includes an electrode including an end portion and a middle portion, the end portion is thicker than the middle portion.

Before any embodiments are explained in detail, it is to be understood that the embodiments are not limited in their application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4.” The relative terminology may refer to plus or minus a percentage (e.g., 1%, 5%, 10%, or more) of an indicated value.

Other aspects of the embodiments will become apparent by consideration of the detailed description and accompanying drawings.

### BRIEF DESCRIPTION OF THE DRAWINGS

FIG. 1 is a perspective view of an electrode for a cable joint according to some examples.

FIG. 2 is a plan view of the electrode of FIG. 1 according to some examples.

FIG. 3 is a cross-section view along a section A-A of the electrode of FIG. 1 according to some examples.

FIG. 4 is a detailed view along a section B of the electrode of FIG. 1 according to some examples.

FIG. 5 is a perspective view of an insulation overmold for the electrode of FIGS. 1-4 according to some examples.

FIG. 6 is a plan view of the insulation overmold of FIG. 5 according to some examples.

FIG. 7 is a cross-section view along a section C-C of the insulation overmold of FIG. 5 according to some examples.

FIG. 8 is a detailed view along a section AN of the insulation overmold of FIG. 5 according to some examples.

FIG. 9 is a detailed view along a section AP of the insulation overmold of FIG. 5 according to some examples.

FIG. 10 is a perspective view of a cable joint including a housing for the electrode of FIGS. 1-4 and insulation overmold of FIGS. 5-10 according to some examples.

FIG. 11 is a plan view of the cable joint of FIG. 10 according to some examples.

FIG. 12 is a cross section view along a section BC-BC of the cable joint of FIG. 10 according to some examples.

FIG. 13 is a detailed view along a section BD of the cable joint of FIG. 10 according to some examples.

In the drawings, reference numbers may be reused to identify similar and/or identical elements.

### DETAILED DESCRIPTION

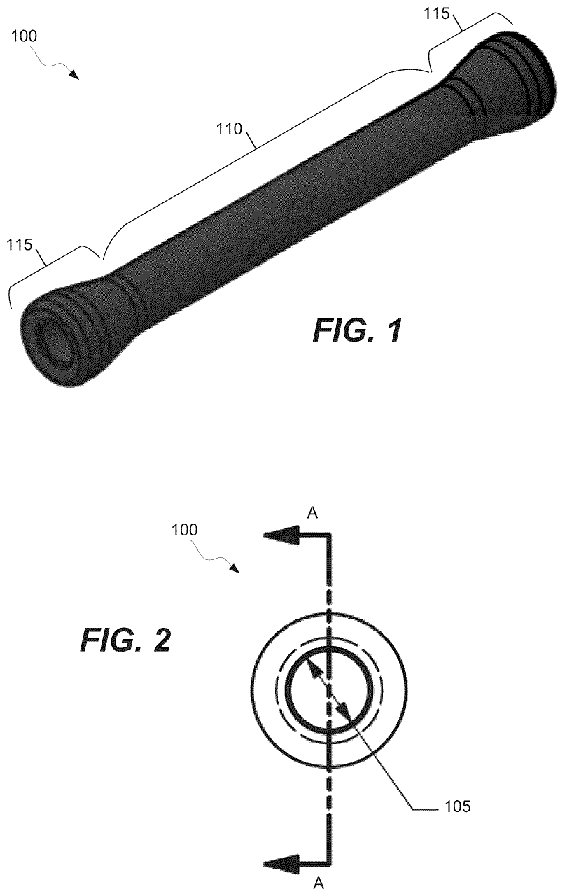

FIGS. 1-4 illustrate an electrode 100 of a cable joint according to some example embodiments. The electrode 100 has a tubular (e.g., cylindrical) shape with a hollow center to receive a connector splicing two electrical cables (e.g., wires). Connectors may come in standard sizes and mechanically connect a first cable and a second cable. The electrode 100 is sized to completely cover the connector and have a length longer than the length of the connector. In one example, the electrode 100 is integrally made with a single material, for example, electrically conductive liquid silicone rubber, ethylene propylene diene monomer (EPDM), or the like. In one example, the electrode 100 is manufactured using a liquid injection molding process, for example, using an overmold and or insert. Other manufacturing processes like compression molding, transfer molding, extrusion, calendaring, or the like may also be used.

Referring to FIG. 2, the electrode 100 may have a relaxed internal diameter 105 that is slightly smaller than the outer diameter of a standardized connector to provide a tight or secure fit over the connector. The relaxed state for the relaxed internal diameter 105 refers to the state of the electrode before being expanded or stretched to facilitate a cold-shrink process (i.e., the cable joint is cold shrinkable). The relaxed internal diameter 105 may be substantially constant throughout the length of the electrode 100.

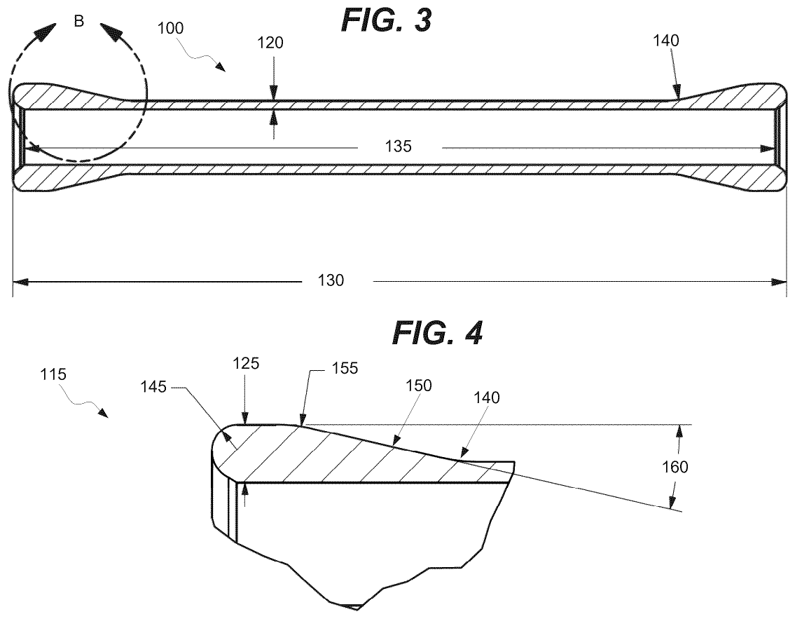

Referring to FIG. 3, the thickness of the electrode 100 varies along the length of the electrode 100. The electrode 100 includes an electrode middle portion 110 (e.g., a first portion) between electrode end portions 115 (e.g., a second portion), referred to singularly as, the electrode end portion 115. The electrode 100 is thicker at the electrode end portion 115 than the electrode middle portion 110. The electrode middle portion 110 is configured to engage the connector and the electrode end portions 115 are configured to engage an insulation of the first cable and an insulator of the second cable respectively. The electrode middle portion 110 has substantially constant (i.e., substantially the same) thickness 120 through the length of the electrode middle portion 110. The electrode end portions 115 may be symmetrical and have varying thickness 125 such that the thickness increases gradually from the electrode middle portion 110. In one example, the thickness (e.g., maximum thickness 125) of the electrode end portion 115 is about 2.8 times the thickness 120 of the electrode middle portion 110. In one example, the thickness of the electrode end portion 115 is between about 1.1 times to 3 times the thickness 120 of the electrode middle portion 110. The relaxed external diameter at each portion may be determined by adding the thickness 120, 125 to the relaxed internal diameter 105. In one example, the electrode end portion 115 is at least 10% thicker than the electrode middle portion 110. In one example, the electrode end portion 115 is at least 20% thicker than the electrode middle portion 110. In one example, the electrode end portion 115 is at least 30% thicker than the electrode middle portion 110. In one example, the electrode end portion 115 is at least 40% thicker than the electrode middle portion 110. In one example, the electrode end portion 115 is at least 50% thicker than the electrode middle portion 110. In one example, the electrode end portion 115 is at least 60% thicker than the electrode middle portion 110. In one example, the electrode end portion 115 is at least 70% thicker than the electrode middle portion 110. In one example, the electrode end portion 115 is at least 80% thicker than the electrode middle portion 110. In one example, the electrode end portion 115 is at least 90% thicker than the electrode middle portion 110. In one example, the electrode end portion 115 is at least 100% thicker than the electrode middle portion 110. In one example, the electrode end portion 115 is between 10% and 100% thicker than the electrode middle portion 110.

The electrode 100 has a total length 130 extending between ends (i.e., opposite the middle portion) of the electrode end portions 115. In some examples, the electrode 100 has an internal length 135 different from the total length 130. The internal length 135 refers to the inside length of the electrode 100 for which portion the internal diameter of the electrode 100 is substantially constant. For example, the internal length 135 may refer to the inside length between the portions where the material of the electrode 100 starts curving outward at the electrode end portion 115 as shown in FIGS. 3-4. In some examples, the electrode 100 may not include a separate internal length, for example, the end portion may not include a curve.

Referring to FIGS. 3-4, the electrode end portion 115 begins when the thickness of the electrode starts to increase (i.e., at the longitudinal end of the electrode middle portion 110). The electrode end portion 115 is shown in detail in FIG. 4. The electrode end portion 115 has a first curvature 140 at the junction of the electrode middle portion 110 and the electrode end portion 115, a concave rounded end 145, a slant portion 150 between the first curvature 140 and the concave rounded end 145, and a second curvature 155 between the slant portion 150 and the concave rounded end 145. The slant portion 150 may be at a small angle 160 (e.g., acute angle at less than 15°) from the middle portion.

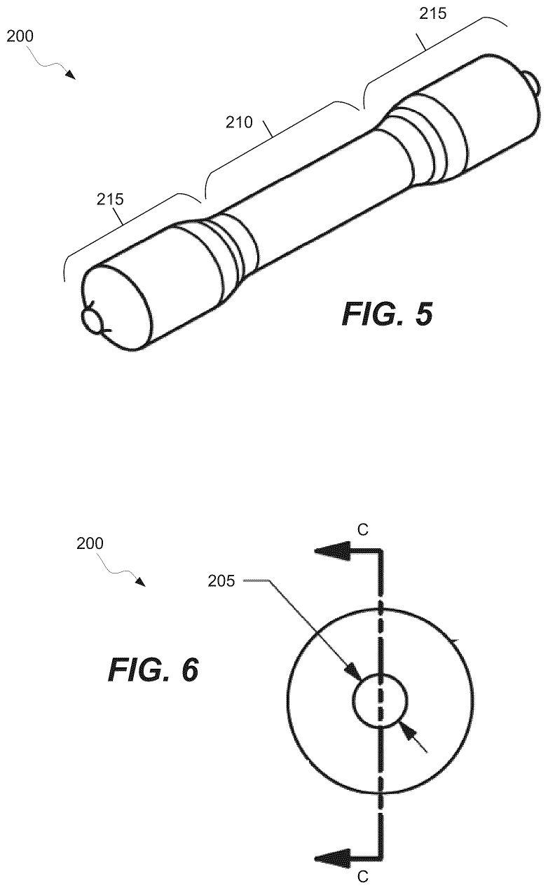

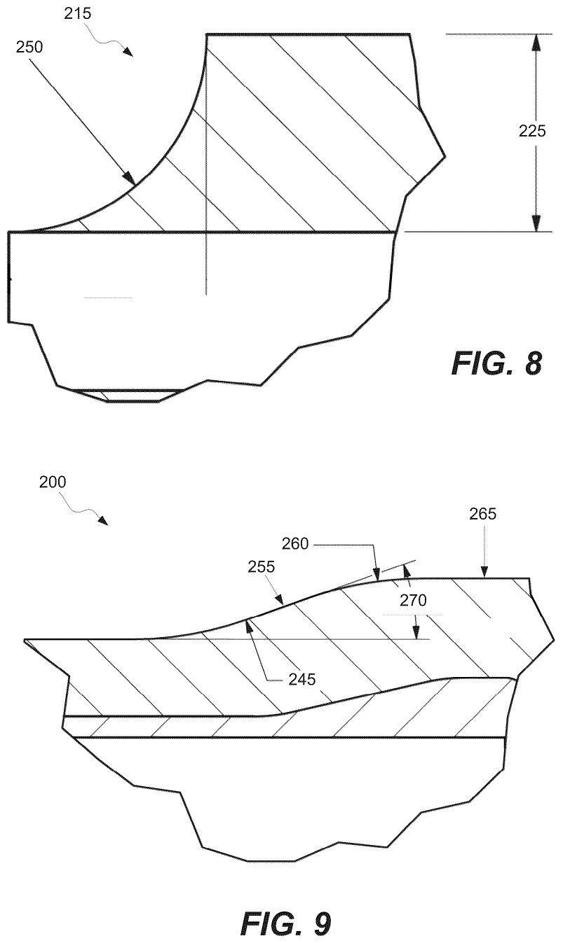

FIGS. 5-9 illustrate an insulation overmold 200 provided over the electrode 100 according to some examples. The insulation overmold 200 has a tubular (e.g., cylindrical) shape with a hollow center to receive the electrode. The insulation overmold 200 is sized to completely cover the electrode 100 and have a length longer than the length of the electrode 100. In one example, the insulation overmold 200 is integrally made with a single material, for example, liquid silicone rubber with a thermally conductive filler. In one example, the insulation overmold 200 is manufactured using a liquid injection molding process around the electrode 100. Other manufacturing processes like compression molding, transfer molding, extrusion, calendaring, or the like may also be used. The insulation overmold 200 may include a cutout for the electrode 100.

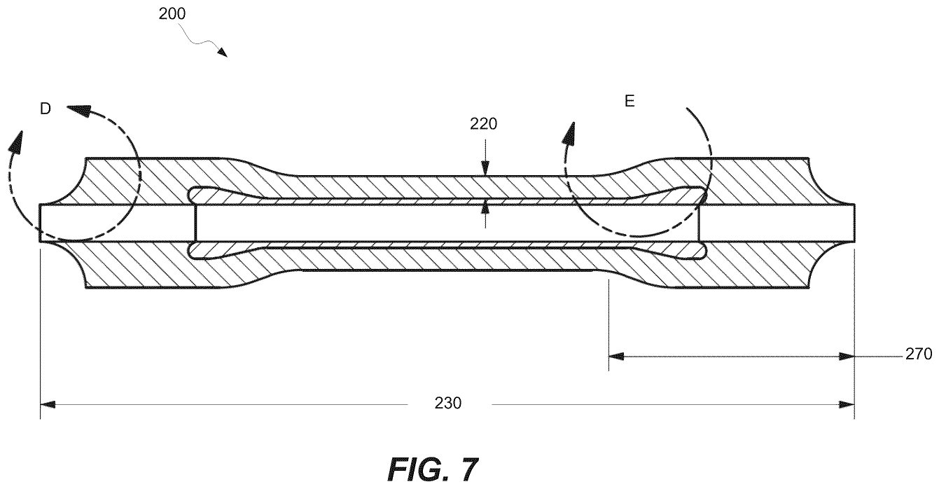

Referring to FIG. 6, the insulation overmold 200 may have a relaxed internal diameter 205 that is substantially the same as the inner diameter of the electrode 100. Referring to FIG. 7, the thickness of the insulation overmold 200 varies along the length of the insulation overmold 200. The insulation overmold 200 includes an insulation middle portion 210 (e.g., a first portion) between insulation end portions 215 (e.g., a second portion), referred to singularly as, the insulation end portion 215. The insulation overmold 200 is thicker at the insulation end portion 215 than the insulation middle portion 210. The insulation middle portion 210 has substantially constant (i.e., substantially the same) thickness 220 through the length of the insulation middle portion 210. The insulation end portions 215 may be symmetrical and have varying thickness 225 such that the thickness increases gradually from the insulation middle portion 210. In one example, the ratio between the thickness of the insulation end portions 215 and the insulation middle portion 210 is similar to ratio between the thickness of the electrode end portions 115 and the electrode middle portions 110. In some example, the ratio between the thickness of the insulation end portions 215 and the insulation middle portion 210 may vary slightly from the ratio between the thickness of the electrode end portions 115 and the electrode middle portions 110. Specifically, the ratio between the thickness of the insulation end portions 215 and the insulation middle portion 210 may take any of the values noted above with respect to the ratio between the thickness of the electrode end portions 115 and the electrode middle portions 110. The electrode 100 has a total length 230 extending between ends (i.e., opposite the middle portion) of the insulation end portions 215.

Referring to FIGS. 7-9, the insulation end portion 215 begins when the thickness of the insulation overmold 200 starts to increase (i.e., at the longitudinal end of the insulation middle portion 210). The insulation end portion 215 has a first curvature 245 at the junction of the insulation middle portion 210 and the insulation end portion 215, a convex rounded end 250, a slant portion 255 between the first curvature 245 and the convex rounded end 250, a second curvature 260 between the slant portion 255 and the convex rounded end 250, and a flat portion 265 between the second curvature 260 and the convex rounded end 250. The slant portion 255 is at a small angle 270 (e.g., an acute angle less than 20°) from the insulation middle portion 210.

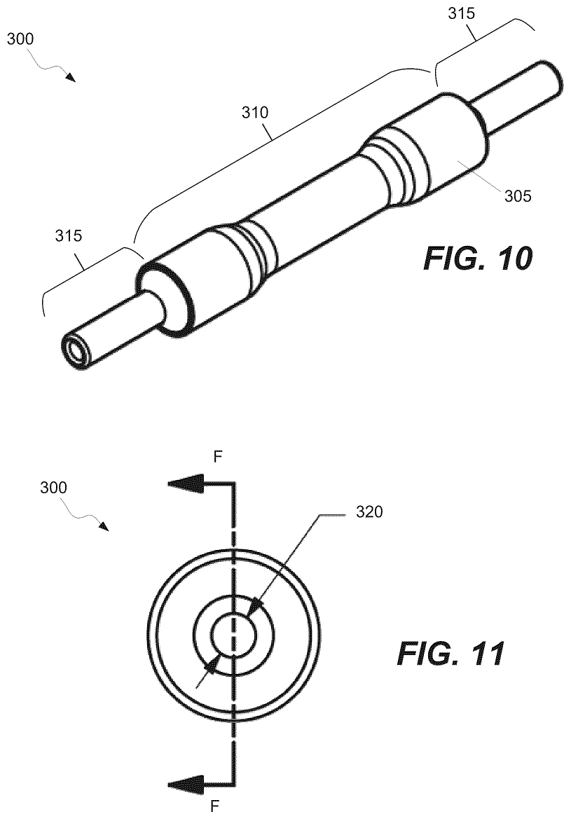

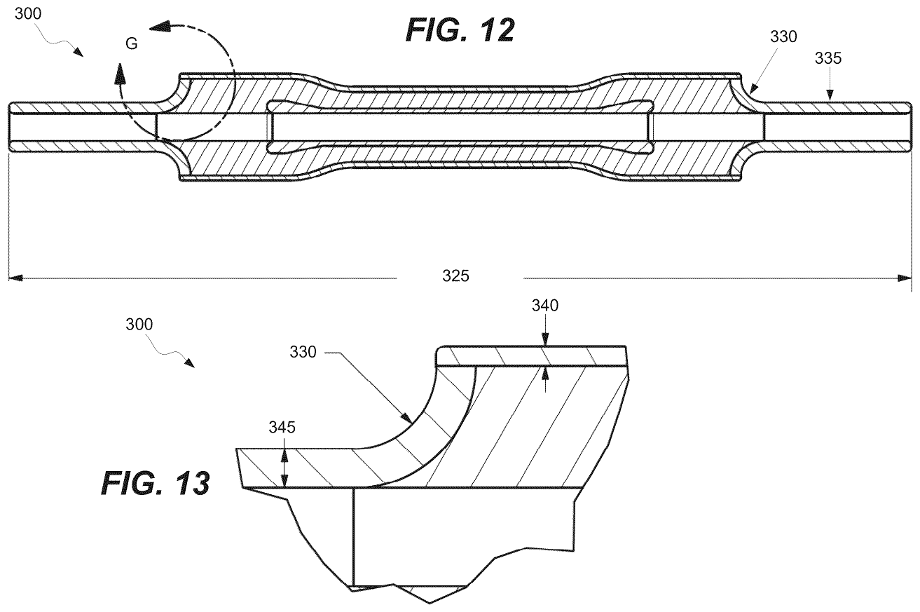

FIGS. 10-13 illustrate a cable joint 300 including a housing 305 provides over the insulation overmold 200 according to some examples. The housing 305 has a tubular (e.g., cylindrical) shape with a hollow center to receive the insulation overmold 200. The housing 305 is sized to completely cover the insulation overmold 200 and have a length longer than the length of the insulation overmold 200. In one example, the housing 305 is integrally made with a single material, for example, liquid silicone rubber, EPDM, or the like. In one example, the housing 305 is manufactured using a liquid injection molding process around the insulation overmold 200. Other manufacturing processes like compression molding, transfer molding, extrusion, calendaring, or the like may also be used. The housing 305 may include a cutout for the insulation overmold 200.

Referring to FIG. 11, the housing 305 includes a housing middle portion 310 (e.g., a first portion) between two housing end portions 315 (e.g., a second portion), referred to singularly as, the housing end portion 315. The housing middle portion 310 extends through the length of the insulation overmolding between the convex rounded ends 250. The housing end portions 315 extend outward axially from the convex rounded ends 250. In the example illustrated, the housing 305 has uniform thickness 340 throughout the middle portion. The housing 305 may have a uniform thickness 345 at the housing end portions 315 which is greater than the uniform thickness 340. The housing end portions 315 have a relaxed internal diameter 320 that is the same as the relaxed internal diameter of the electrode 100 and the insulation overmold 200 and continues the cylindrical openings of the electrode 100 and the insulation overmold 200. The housing end portions 315 may be symmetrical. The housing 305 has a total housing length 325 extending between axial ends of the housing end portions 315.

Referring to FIG. 13, the housing end portion 315 includes a housing curved portion 330 corresponding to the convex rounded end 250 of the insulation overmold 200 and a housing flat portion 335 extending from the housing curved portion 330 to the axial end of the housing 305. The housing middle portion 310 extends between the tops of the housing curved portions 330.

The electrode 100, the insulation overmold 200, and the housing 305 may have a different configuration than described herein. The electrode 100 has an electrode end portion 115 thicker than the electrode middle portion 110. Other features may be modified based on the design requirements. The measurements provided herein apply generally to the standard sizes, for example corresponding to IEEE 404. However, the sizing of the various components may be varied such that the cable joint 300 can be used according to IEEE 404. As used herein, an axial direction refers to the direction along the axis of the hollow portion of the electrode 100.

Thus, embodiments described herein provide, among other things, a thermally optimized cable joint.

What is claimed is:

1. A cable joint comprising:
an electrode including an end portion and a middle portion, the end portion being thicker than the middle portion; and
an insulation overmold provided over the electrode, the insulation overmold including an overmold end portion and an overmold middle portion, the overmold end portion being thicker than the overmold middle portion.

2. The cable joint of claim 1, wherein the electrode is hollow between the end portion and the middle portion wherein an internal diameter is substantially the same between the end portion and the middle portion.

3. The cable joint of claim 1, wherein the electrode is made of electrically conductive liquid silicone rubber.

4. The cable joint of claim 1, wherein the end portion is at least 10% thicker than the middle portion.

5. The cable joint of claim 4, wherein the end portion is at least 50% thicker than the middle portion.

6. The cable joint of claim 5, wherein the end portion is at least 100% thicker than the middle portion.

7. The cable joint of claim 1, wherein a thickness of the electrode at the end portion is about 2.8 times a thickness of the electrode at the middle portion.

8. The cable joint of claim 1, wherein the electrode is cold shrinkable.

9. The cable joint of claim 1, further comprising: a joint housing provided over the insulation overmold, the joint housing including a first portion provided over the insulation overmold and a second portion extending axially from the first portion, the first portion has substantially the same thickness through the length of the first portion.

10. A cable joint comprising: an electrode including an end portion and a middle portion, the end portion being thicker than the middle portion.

11. The cable joint of claim 10, wherein the electrode is hollow between the end portion and the middle portion wherein an internal diameter is substantially the same between the end portion and the middle portion.

12. The cable joint of claim 10, wherein the electrode is made of electrically conductive liquid silicone rubber.

13. The cable joint of claim 10, wherein the end portion is at least 10% thicker than the middle portion.

14. The cable joint of claim 13, wherein the end portion is at least 50% thicker than the middle portion.

15. The cable joint of claim 14, wherein the end portion is at least 100% thicker than the middle portion.

16. The cable joint of claim 10, wherein a thickness of the electrode at the end portion is about 2.8 times a thickness of the electrode at the middle portion.

17. The cable joint of claim 10, wherein the electrode is cold shrinkable.

18. The cable joint of claim 10, wherein the middle portion is configured to engage a connector that mechanically connects a first cable and a second cable and the end portion is configured to engage an insulator of the first cable or an insulator of the second cable.

19. The cable joint of claim 18, further comprising: an insulation overmold provided over the electrode, the insulation overmold including an overmold end portion and an overmold middle portion, the overmold end portion being thicker than the overmold middle portion.

20. The cable joint of claim 19, further comprising: a joint housing provided over the insulation overmold, the joint housing including a first portion provided over the insulation overmold and a second portion extending axially from the first portion, the first portion has substantially the same thickness through the length of the first portion.
